(19) United States
(12) Patent Application Publication
(10) Pub. No.: US 2025/0158672 A1
(43) Pub. Date: May 15, 2025

(54) PARAMETERS FOR LATTICE REDUCTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/715,440

(22) PCT Filed: Feb. 28, 2022
(86) PCT No.: PCT/CN2022/078201

§ 371 Date: May 31, 2024

(51) Int. Cl. H04B 7/0456

(52) U.S. Cl. CPC H04B 7/0456

(57) ABSTRACT

Various aspects of the present disclosure generally relate to wireless communication. In some aspects, a user equipment (UE) may obtain an indication of a performance-complexity tradeoff parameter value associated with a quantity of iterations and channel orthogonality for an algorithm for a lattice reduction of a first matrix for a downlink communication, a frequency domain granularity for the lattice reduction, and/or a time domain granularity for the lattice reduction. The UE may receive the downlink communication that corresponds to the first matrix and perform the lattice reduction to transfer the first matrix to a second matrix based at least in part on the performance-complexity tradeoff parameter value, the frequency domain granularity, and/or the time domain granularity. The UE may perform multiple-input-multiple-output detection of the downlink communication using the second matrix. Numerous other aspects are described.

### FIELD OF THE DISCLOSURE

Aspects of the present disclosure generally relate to wireless communication and to techniques and apparatuses for obtaining parameters for lattice reduction.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include obtaining one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The method may include receiving the downlink communication that corresponds to the first matrix. The method may include performing the lattice reduction to transfer the first matrix to a second matrix based at least in part on the one or more of the performance-complexity tradeoff parameter value, the frequency domain granularity, or the time domain granularity. The method may include performing multiple-input-multiple-output (MIMO) detection of the downlink communication using the second matrix.

Some aspects described herein relate to a method of wireless communication performed by a network entity. The method may include generating an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The method may include transmitting the indication. The method may include transmitting the downlink communication.

Some aspects described herein relate to a UE for wireless communication. The UE may include a memory and one or more processors coupled to the memory. The one or more processors may be configured to obtain one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The one or more processors may be configured to receive the downlink communication that corresponds to the first matrix. The one or more processors may be configured to perform the lattice reduction to transfer the first matrix to a second matrix based at least in part on the one or more of the performance-complexity tradeoff parameter value, the frequency domain granularity, or the time domain granularity. The one or more processors may be configured to perform MIMO detection of the downlink communication using the second matrix.

Some aspects described herein relate to a network entity for wireless communication. The network entity may include a memory and one or more processors coupled to the memory. The one or more processors may be configured to generate an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The one or more processors may be configured to transmit the indication. The one or more processors may be configured to transmit the downlink communication.

Some aspects described herein relate to a non-transitory computer-readable medium that stores a set of instructions for wireless communication by a UE. The set of instructions, when executed by one or more processors of the UE, may cause the UE to obtain one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The set of instructions, when executed by one or more processors of the UE, may cause the UE to receive the downlink communication that corresponds to the first matrix. The set of instructions, when executed by one or more processors of the UE, may cause the UE to perform the lattice reduction to transfer the first matrix to a second matrix based at least in part on the one or more of the performance-complexity tradeoff parameter value, the frequency domain granularity, or the time domain granularity. The set of instructions, when executed by one or more processors of the UE, may cause the UE to perform MIMO detection of the downlink communication using the second matrix.

Some aspects described herein relate to a non-transitory computer-readable medium that stores a set of instructions for wireless communication by a network entity. The set of instructions, when executed by one or more processors of the network entity, may cause the network entity to generate an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The set of instructions, when executed by one or more processors of the network entity, may cause the network entity to transmit the indication. The set of instructions, when executed by one or more processors of the network entity, may cause the network entity to transmit the downlink communication.

Some aspects described herein relate to an apparatus for wireless communication. The apparatus may include means for obtaining one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The apparatus may include means for receiving the downlink communication that corresponds to the first matrix. The apparatus may include means for performing the lattice reduction to transfer the first matrix to a second matrix based at least in part on the one or more of the performance-complexity tradeoff parameter value, the frequency domain granularity, or the time domain granularity. The apparatus may include means for performing MIMO detection of the downlink communication using the second matrix.

Some aspects described herein relate to an apparatus for wireless communication. The apparatus may include means for generating an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The apparatus may include means for transmitting the indication. The apparatus may include means for transmitting the downlink communication.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of a slot format, in accordance with the present disclosure.

FIG. 5 is a diagram illustrating examples of lattices associated with multiple-input-multiple-output detection, in accordance with the present disclosure.

FIG. 6 is a diagram illustrating an example associated with obtaining parameters for lattice reduction, in accordance with the present disclosure.

FIG. 7 is a diagram illustrating an example process performed, for example, by a UE, in accordance with the present disclosure.

FIG. 8 is a diagram illustrating an example process performed, for example, by a network entity, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

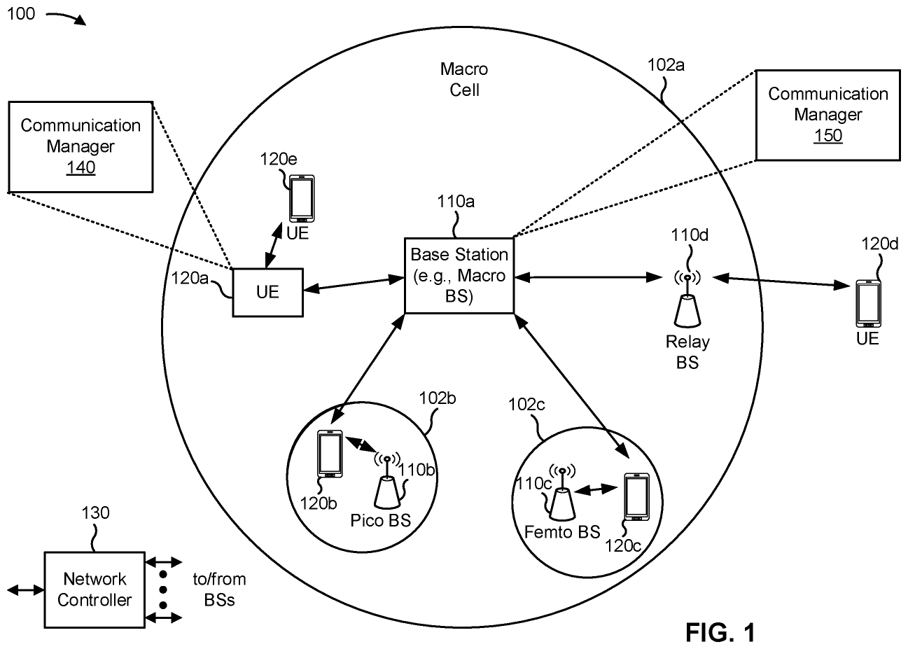

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120c). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may obtain one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The communication manager 140 may receive the downlink communication that corresponds to the first matrix and perform the lattice reduction to transfer the first matrix to a second matrix based at least in part on the one or more of the performance-complexity tradeoff parameter value, the frequency domain granularity, or the time domain granularity. The communication manager 140 may perform MIMO detection of the downlink communication using the second matrix. Additionally, or alternatively, the communication manager 140 may perform one or more other operations described herein.

In some aspects, a network entity (e.g., base station 110) may include a communication manager 150. As described in more detail elsewhere herein, the communication manager 150 may generate an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The communication manager 150 may transmit the indication and transmit the downlink communication. Additionally, or alternatively, the communication manager 150 may perform one or more other operations described herein.

As indicated above, FIG. 1 is provided as an example. Other examples may differ from what is described with regard to FIG. 1.

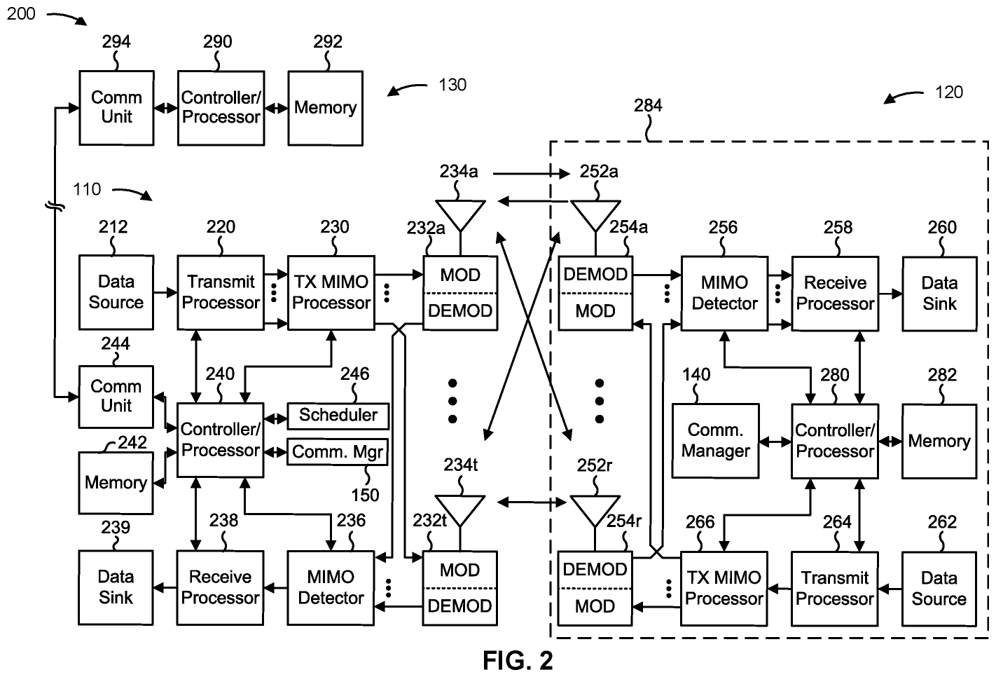

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

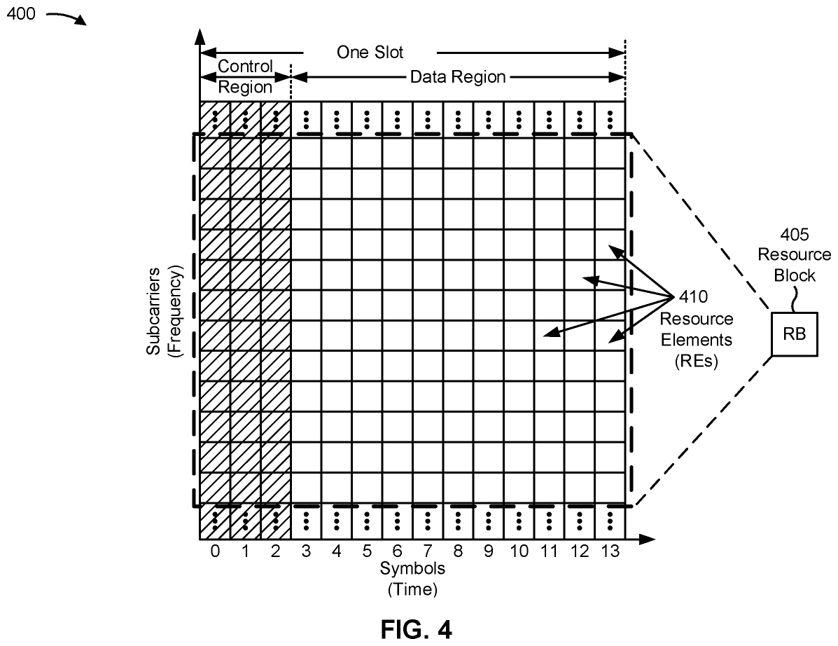

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

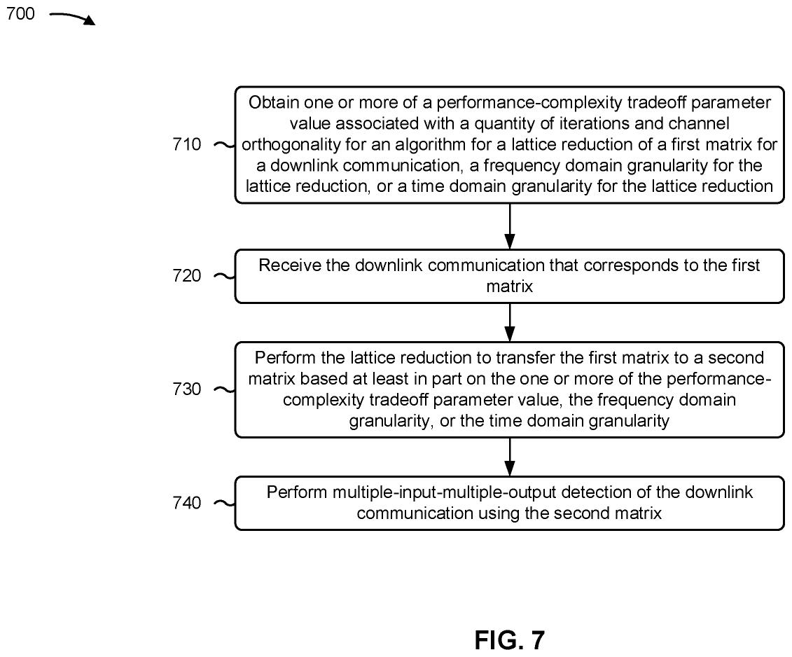

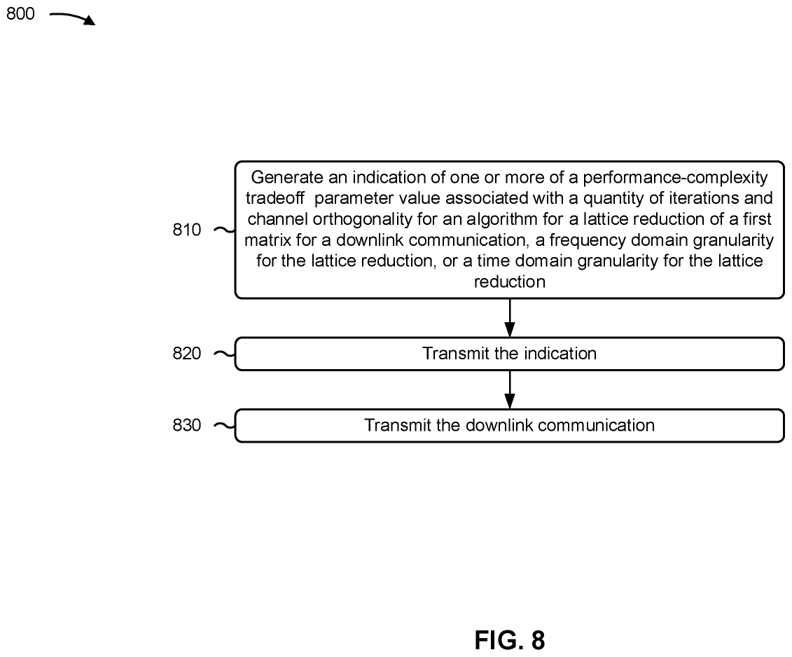

A controller/processor of a network entity, (e.g., the controller/processor 240 of the base station 110), the controller/processor 280 of the UE 120, and/or any other component(s) of FIG. 2 may perform one or more techniques associated with using a tradeoff parameter, a time domain granularity, and/or a frequency domain granularity for lattice reduction, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for obtaining one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction; means for receiving the downlink communication that corresponds to the first matrix; means for performing the lattice reduction to transfer the first matrix to a second matrix based at least in part on the one or more of the performance-complexity tradeoff parameter value, the frequency domain granularity, or the time domain granularity; and/or means for performing MIMO detection of the downlink communication using the second matrix. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for generating an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction; means for transmitting the indication; and/or means for transmitting the downlink communication. The means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

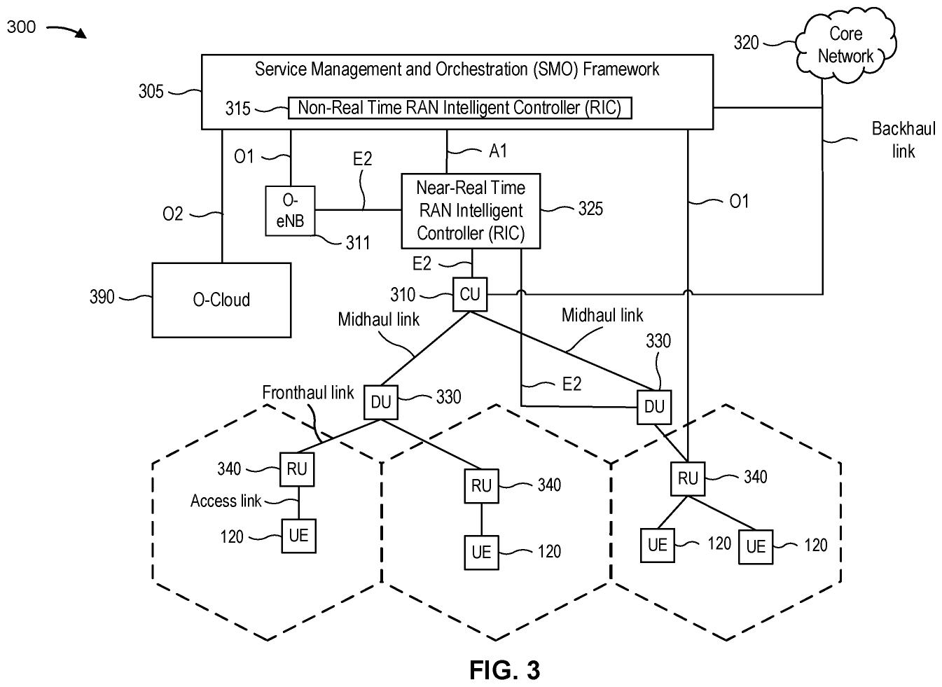

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (CNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)).

Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUS (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 is a diagram illustrating an example 400 of a slot format, in accordance with the present disclosure. As shown in FIG. 4, time-frequency resources in a radio access network may be partitioned into resource blocks, shown by a single resource block (RB) 405. An RB 405 is sometimes referred to as a physical resource block (PRB). An RB 405 includes a set of subcarriers (e.g., 12 subcarriers) and a set of symbols (e.g., 14 symbols) that are schedulable by a base station 110 as a unit. In some aspects, an RB 405 may include a set of subcarriers in a single slot. As shown, a single time-frequency resource included in an RB 405 may be referred to as a resource element (RE) 410. An RE 410 may include a single subcarrier (e.g., in frequency) and a single symbol (e.g., in time). A symbol may be referred to as an OFDM symbol. An RE 410 may be used to transmit one modulated symbol, which may be a real value or a complex value.

In some telecommunication systems (e.g., NR), RBs 405 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a PRACH used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

The PDCCH or the PUCCH may include a DMRS, among other signals. A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

Downlink communications may include downlink semi-persistent scheduling (SPS) communications and/or configured grant (CG) communications. SPS communications may include periodic downlink communications that are configured for a UE, such that the base station does not need to send separate DCI to schedule each downlink communication, thereby conserving signaling overhead. CG communications may include periodic uplink communications that are configured for a UE, such that the base station does not need to send separate DCI to schedule each uplink communication, thereby conserving signaling overhead.

A UE may be configured with an SPS configuration for SPS communications. For example, the UE may receive the SPS configuration via an RRC message transmitted by a base station. The SPS configuration may indicate a resource allocation associated with SPS downlink communications (e.g., in a time domain, frequency domain, spatial domain, and/or code domain) and a periodicity at which the resource allocation is repeated, resulting in periodically reoccurring scheduled SPS occasions for the UE. The SPS configuration may also configure hybrid automatic repeat request (HARQ)-ACK feedback resources for the UE to transmit HARQ-ACK feedback for SPS PDSCH communications received in the SPS occasions.

The base station may transmit SPS activation DCI to the UE to activate the SPS configuration for the UE. The base station may indicate, in the SPS activation DCI, communication parameters, such as an MCS, an RB allocation, and/or antenna ports, for the SPS PDSCH communications to be transmitted in the scheduled SPS occasions. The base station may transmit SPS reactivation DCI to the UE to change the communication parameters for the SPS PDSCH communications. In some cases, such as when the base station does not have downlink traffic to transmit to the UE, the base station may transmit SPS cancellation DCI to the UE to temporarily cancel or deactivate one or more subsequent SPS occasions for the UE. The base station may transmit SPS release DCI to the UE to deactivate the SPS configuration for the UE.

A UE may be configured with a CG configuration for CG communications. For example, the UE may receive the CG configuration via an RRC message transmitted by a base station. The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure).

The base station may transmit CG activation DCI to the UE to activate the CG configuration for the UE. The base station may indicate, in the CG activation DCI, communication parameters, such as an MCS, an RB allocation, and/or antenna ports, for the CG-PUSCH communications to be transmitted in the scheduled CG occasions. The UE may begin transmitting in the CG occasions based at least in part on receiving the CG activation DCI. The base station may transmit CG reactivation DCI to the UE to change the communication parameters for the CG PUSCH communications. In some cases, such as when the base station needs to override a scheduled CG communication for a higher priority communication, the base station may transmit CG cancellation DCI to the UE to temporarily cancel or deactivate one or more subsequent CG occasions for the UE. The base station may transmit CG release DCI to the UE to deactivate the CG configuration for the UE.

As indicated above, FIG. 4 is provided as an example. Other examples may differ from what is described with respect to FIG. 4.

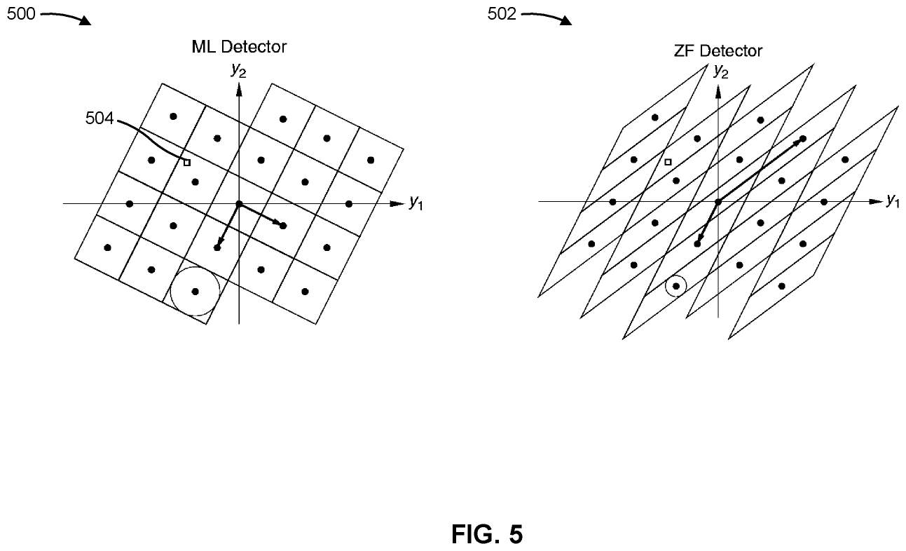

FIG. 5 is a diagram illustrating examples 500 and 502 of lattices associated with MIMO detection, in accordance with the present disclosure.

A UE may use MIMO detection to detect one or more vectors on a MIMO channel, to determine a channel matrix for the channel. The channel matrix indicates how data streams are received on the channel at multiple spatial antennas. Optimal MIMO detection (e.g., maximum-likelihood (ML) or maximum a posteriori probability (MAP)) involves computational complexity that grows exponentially with the number of antennas, while linear MIMO detection schemes (e.g., zero-forcing (ZF), minimum mean square error (MMSE), ZF successive interference cancellation (SIC) (ZF-SIC), MMSE-SIC) cannot achieve full receive diversity. One reason for the degraded performance of the linear detection schemes is that when a channel lacks orthogonality, linear filters make the filtered signals more vulnerable to noise.

Lattices may be used for detection and precoding in MIMO systems. A lattice may be a patterned arrangement of data points or superimposed integer multiples of a vector in a Euclidean plane. For MIMO detection, a lattice may correspond to the channel matrix for a MIMO channel. Lattice reduction may help improve detection of the MIMO channel. Lattice reduction may include reducing a first basis (matrix) to a reduced second basis (matrix), solving a detection/coding problem with the second matrix, and transforming a solution back into the same domain (e.g., constellation) as the first matrix. The second matrix may have better properties (e.g., more orthogonality) or shorter vectors than the first matrix. The first matrix and the second matrix may be related via a unimodular transformation matrix.

Example 500 shows decision regions of a rotated square receive lattice for a ML detector for detecting a transmitted data vector on a MIMO channel. A receive vector 504 is located in a decision region of a closest lattice point. Detection of the transmitted data vector involves selection of the closest lattice point to the receive vector 504. Example 502 shows a ZF detector in which decision regions are given by shifted versions of a fundamental parallelogram, which do not provide as much orthogonality as the ML detector.

In other words, lattice reduction for MIMO detection may be based on a linear matrix transfer of the original MIMO channel to a more orthogonal matrix based on certain transfer matrices. The solution (e.g., MIMO detection) may be transformed back to the original (e.g., quadrature amplitude modulation (QAM)) constellation. When a MIMO channel is quasi-stationary (in the time domain or the frequency domain), lattice reduction can be applied to the jointly quasi-stationary channels with identical transfer matrices. The resulting MIMO detection may achieve the same spatial diversity order as achieved by an ML detector. Lattice reduction may be applicable when the MIMO channel is less orthogonal due to strong line of sight dominance.

Lattice reduction may involve different techniques, including Minkowski reduction, Hermite-Korkine-Zolotareff reduction, Gauss reduction, Lenstra-Lenstra-Lovász (LLL) reduction, Seysen reduction, or Brun reduction. Such techniques may involve transforming a first matrix to a second matrix by reflection (sign change), column swapping, and/or translation (adding one column to another column). Transforming the first matrix to the second matrix may include applying a unimodular translation matrix.

The LLL algorithm, for example, is a popular iterative algorithm that involves a parameter with a value that is associated with a tradeoff between performance (e.g., channel orthogonality) and computational complexity (e.g., quantity of iterations). This performance-complexity tradeoff parameter value may be referred to as a “delta” parameter value (e.g., δ=3/4) and may be multiplied against one of the quantities in a condition of the LLL algorithm. A higher performance-complexity tradeoff parameter value results in a higher basis (e.g., more orthogonal matrix), but at the cost of higher complexity.

The optimal values of the tradeoff (delta) parameter in the LLL algorithm, the time domain granularity (e.g., how many subcarriers), and the frequency domain granularity (e.g., how many slots or symbols) for lattice reduction may depend on one or more factors. These factors may include, among other examples, a target block error rate (BLER), a constellation size, frequency selectivity, a quantity of antenna ports, Doppler or coherence time, a latency requirement, and/or UE processing capability. For example, lattice reduction at delta=0.55 can achieve an uncoded bit error rate (BER) similar to that of delta=0.99 with 4 transmit and receive antennas with 4QAM or 16QAM in flat Rayleigh fading. That is, a target BLER can be achieved by delta=0.55. That is, large delta values may not be needed for lattice reduction.

However, simply relying on UE implementation to determine the best value for the tradeoff parameter can be complex and consume a great amount of processing resources. For example, determining which RBs are correlated and thus can be considered with a single lattice reduction operation may cost more in complexity than the lattice reduction itself.

According to various aspects described herein, a network entity (e.g., gNB) may obtain factors via channel state information (CSI) or sounding reference signal (SRS) measurements and use the factors to indicate, to the UE, parameters for an optimum tradeoff value, a time domain granularity, and/or a frequency domain granularity for lattice reduction. In some aspects, in addition to or instead of providing such parameters, the network entity may provide some lower-complexity machine learning models that are trained by the network entity. The UE can input factors, such as the factors described above into the models and obtain the tradeoff and granularity parameters for lattice reduction. As a result of obtaining better tradeoff and granularity parameters for lattice reduction, the UE may achieve better MIMO detection while consuming less processing resources.

As indicated above, FIG. 5 is provided as an example. Other examples may differ from what is described with regard to FIG. 5.

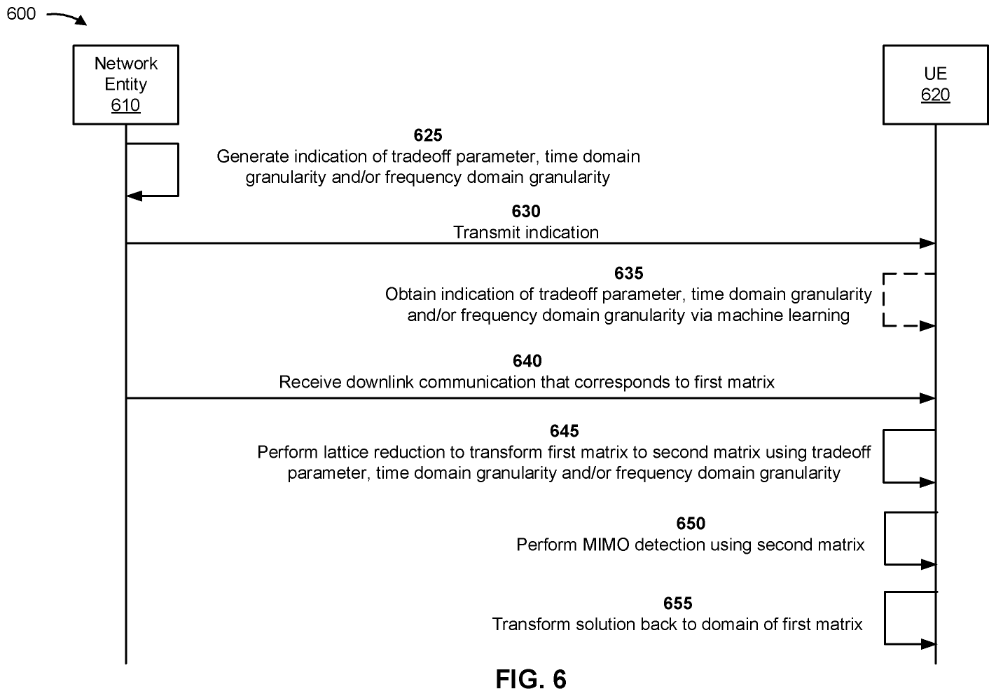

FIG. 6 is a diagram illustrating an example 600 associated with obtaining parameters for lattice reduction, in accordance with the present disclosure. As shown in FIG. 6, a network entity 610 (e.g., base station 110) and a UE 620 (e.g., a UE 120) may communicate with one another.

The UE 620 may obtain a performance-complexity tradeoff parameter value (e.g., convergence parameter delta in an LLL-algorithm) associated with a quantity of iterations and channel orthogonality for an algorithm for a lattice reduction of a first matrix for a downlink communication. The UE 620 may also obtain a frequency domain granularity for the lattice reduction and/or a time domain granularity for the lattice reduction. The frequency domain granularity for lattice reduction may correspond to how many and/or over which OFDM tones for which the UE 620 is to consider the MIMO channel to be identical, such that the UE 620 applies a single corresponding lattice reduction over the tones. The time domain granularity for lattice reduction may correspond to how many symbols/slots for which the UE 620 is to consider the MIMO channel to be identical, such that the UE 620 applies a single corresponding lattice reduction the symbols/slots.

In some aspects, as shown by reference number 625, the network entity 610 may generate an indication of such parameters based at least in part on CSI and/or measurements of a reference signal (e.g., SRS). As shown by reference number 630, the network entity 610 may transmit the indication (e.g., via downlink grant DCI, an RRC configuration, or a MAC CE). The RRC message may be a configuration of an SPS-PDSCH. The MAC CE may update PDSCH detection/demapping (applied to a quantity of PDSCH communications based on a timer and/or MAC CE/DCI deactivation commands). The UE 620 may prepare to use the parameters for multi-layer PDSCH detection/demapping or multi-layer PUSCH precoding.

Alternatively, or additionally, as shown by reference number 635, the UE 620 may obtain such parameters by performing machine learning with one or more machine learning models, using model inputs that include, among other examples, packet data protocol information, a coarse frequency selectivity level, an actual frequency selectivity level, a coarse channel singularity level (e.g., wideband-specific or subband-specific channel singularity factors), an actual channel singularity level, coarse Doppler information, actual Doppler information, coarse Doppler spread information, and/or actual Doppler spread information. “Coarse” may refer to what the network entity 610 estimated based at least in part on an SRS. “Actual” may refer to what the UE 620 estimated based at least in part on a downlink reference signal. The model inputs may also include channel coherence time information, a target BLER, a constellation size, an MCS, a quantity of layers, a quantity of receive antennas, and/or a history of channel measurements. Model outputs may include the tradeoff parameter, the time domain granularity, and/or the frequency domain granularity.

In some aspects, the network entity 610 may indicate course parameter values that are refined by machine learning at the UE 620, and the network entity 610 may provide models for the machine learning to the UE 620. The network entity 610 may also use similar models and/or inputs to generate the indication that was described in connection with reference number 625. The network entity 610 may signal certain factors to the UE 620, including a BLER, a constellation size, an MCS, or channel profile information. The machine learning may also be enhanced with assistance from an air interface.

In some aspects, the network entity 610 may indicate one or more frequency selective tradeoff values for a lattice reduction algorithm, such as an LLL algorithm. For example, the tradeoff value may be specific to a frequency subband, a bandwidth part (BWP), or a serving cell. The tradeoff value may be associated with a constellation size and/or a quantity of layers. When the constellation size is large (e.g., 64 QAM or 256 QAM), demodulation may comprise high dominance in the overall complexity as compared to a smaller constellation size (e.g., 4QAM), such that a greater tradeoff value (e.g., 0.99) maybe signaled for such a large constellation size, while a smaller constellation size may be signaled with a smaller delta value (e.g., 0.55).

As shown by reference number 640, the network entity 610 may transmit a downlink communication that corresponds to the first matrix. As shown by reference number 645, the UE 620 may perform lattice reduction using the tradeoff parameter, the time domain granularity, and/or the frequency domain granularity. For example, the time domain granularity may indicate one or more symbols or slots, and the UE 620 may apply the lattice reduction identically across the one or more symbols or slots.

Lattice reduction may depend on the presence of DMRSs. For example, the UE 620 may be scheduled with a PDSCH communication, with or without DMRSs. The UE 620 may autonomously determine that lattice reduction is to be carried out if the PDSCH communication includes a DMRS. In some aspects, the UE 620 may disable lattice reduction or refrain from performing lattice reduction if the PDSCH communication includes multiple DMRS symbols in a single PDSCH communication.

The frequency domain granularity may indicate one or more subbands (subcarriers), and the UE 620 may apply the lattice reduction identically across the one or more subbands. The frequency domain granularity may correspond to a precoding resource block granularity (PRG) or to an RB group that is associated with a PRG. For example, the frequency domain granularity for lattice reduction may be configured or predefined to be the same as a PRG size. In another example, a single PRG may include multiple RB groups, where each RB group is considered with an identical MIMO channel and a single corresponding lattice reduction.

As shown by reference number 650, the UE 620 may perform MIMO detection using the second matrix. As shown by reference number 655, the UE 620 may transform the solution of the MIMO detection back to a domain (e.g., constellation size) of the first matrix. This may include matrix transformation operations related to the transformation from the first matrix to the second matrix.

By applying an indicated or learned tradeoff parameter with an indicated or learned time domain granularity and frequency domain granularity, MIMO detection may be improved while conserving processing resources at the UE.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., a UE 120, UE 620) performs operations associated with using parameters for lattice reduction.

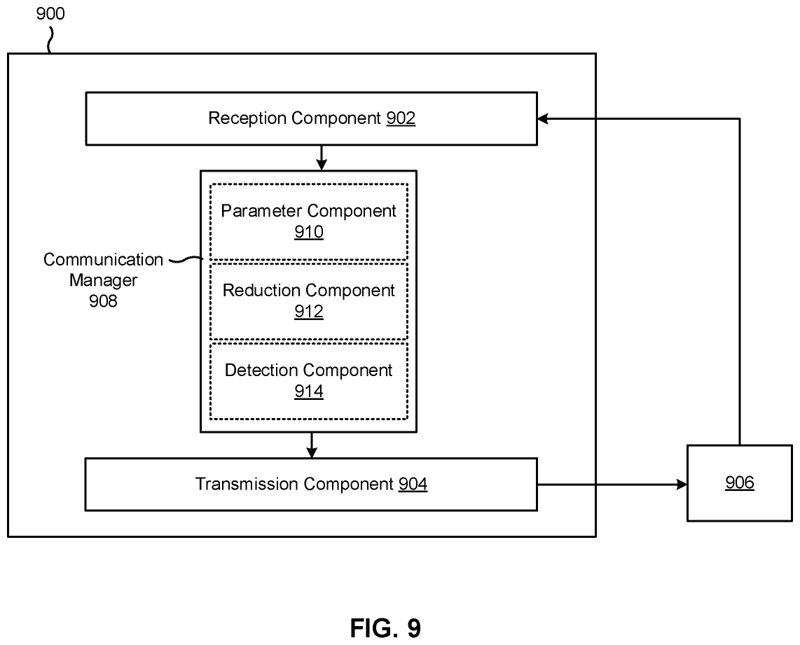

As shown in FIG. 7, in some aspects, process 700 may include obtaining one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction (block 710). For example, the UE (e.g., using communication manager 908 and/or parameter component 910 depicted in FIG. 9) may obtain one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction, as described above.

As further shown in FIG. 7, in some aspects, process 700 may include receiving the downlink communication that corresponds to the first matrix (block 720). For example, the UE (e.g., using communication manager 908 and/or reception component 902 depicted in FIG. 9) may receive the downlink communication that corresponds to the first matrix, as described above.

As further shown in FIG. 7, in some aspects, process 700 may include performing the lattice reduction to transfer the first matrix to a second matrix based at least in part on the one or more of the performance-complexity tradeoff parameter value, the frequency domain granularity, or the time domain granularity (block 730). For example, the UE (e.g., using communication manager 908 and/or reduction component 912 depicted in FIG. 9) may perform the lattice reduction to transfer the first matrix to a second matrix based at least in part on the one or more of the performance-complexity tradeoff parameter value, the frequency domain granularity, or the time domain granularity, as described above.

As further shown in FIG. 7, in some aspects, process 700 may include performing MIMO detection of the downlink communication using the second matrix (block 740). For example, the UE (e.g., using communication manager 908 and/or detection component 914 depicted in FIG. 9) may perform MIMO detection of the downlink communication using the second matrix, as described above.

Process 700 may include additional aspects, such as any single aspect or any combination of aspects described below and/or in connection with one or more other processes described elsewhere herein.

In a first aspect, the frequency domain granularity indicates one or more subbands, and performing the lattice reduction based at least in part on the frequency domain granularity includes applying the lattice reduction identically across the one or more subbands.

In a second aspect, alone or in combination with the first aspect, the frequency domain granularity corresponds to a PRG, or a size of a PRG.

In a third aspect, alone or in combination with one or more of the first and second aspects, the frequency domain granularity corresponds to an RB group associated with a PRG.

In a fourth aspect, alone or in combination with one or more of the first through third aspects, the time domain granularity indicates one or more symbols or slots, and performing the lattice reduction based at least in part on the time domain granularity includes applying the lattice reduction identically across the one or more symbols or slots.

In a fifth aspect, alone or in combination with one or more of the first through fourth aspects, performing the lattice reduction includes performing the lattice reduction based at least in part on a determination that the downlink communication includes a DMRS.

In a sixth aspect, alone or in combination with one or more of the first through fifth aspects, performing the lattice reduction includes performing the lattice reduction based at least in part on a determination that the downlink communication does not include multiple DMRSs.

In a seventh aspect, alone or in combination with one or more of the first through sixth aspects, process 700 includes disabling a lattice reduction of a next downlink communication based at least in part on a determination that the next downlink communication includes multiple demodulation reference signals.

In an eighth aspect, alone or in combination with one or more of the first through seventh aspects, obtaining the performance-complexity tradeoff parameter value, the frequency domain granularity, or the time domain granularity includes receiving an indication of the performance-complexity tradeoff parameter value, the frequency domain granularity, or the time domain granularity via a downlink grant DCI, an RRC configuration, or a MAC CE.

In a ninth aspect, alone or in combination with one or more of the first through eighth aspects, process 700 includes receiving an indication of one or more of a block error rate, a constellation size, an MCS, or channel profile information.

In a tenth aspect, alone or in combination with one or more of the first through ninth aspects, the performance-complexity tradeoff parameter value is specific to a frequency subband, a BWP, or a serving cell.

In an eleventh aspect, alone or in combination with one or more of the first through tenth aspects, the performance-complexity tradeoff parameter value is associated with one or more of a constellation size or a quantity of layers.

In a twelfth aspect, alone or in combination with one or more of the first through eleventh aspects, obtaining the indication includes performing machine learning with one or more model inputs.

In a thirteenth aspect, alone or in combination with one or more of the first through twelfth aspects, the one or more model inputs include one or more of packet data protocol information, a coarse frequency selectivity level, an actual frequency selectivity level, a coarse channel singularity level, an actual channel singularity level, Doppler information, actual Doppler information, Doppler spread information, actual Doppler spread information, channeling coherence time information, a target BLER, a constellation size, an MCS, a quantity of layers, a quantity of receive antennas, or a history of channel measurements.

In a fourteenth aspect, alone or in combination with one or more of the first through thirteenth aspects, process 700 includes receiving one or more models for the machine learning.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., base station 110, network entity 610) performs operations associated with indicating parameters or machine learning models for lattice reduction.

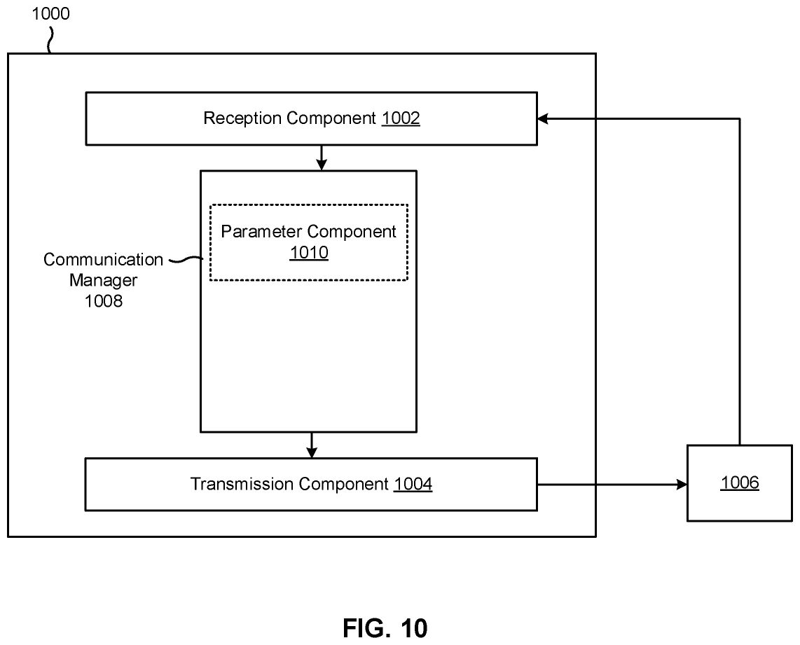

As shown in FIG. 8, in some aspects, process 800 may include generating an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction (block 810). For example, the network entity (e.g., using communication manager 1008 and/or parameter component 1010 depicted in FIG. 10) may generate an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction, as described above.

As further shown in FIG. 8, in some aspects, process 800 may include transmitting the indication (block 820). For example, the network entity (e.g., using communication manager 1008 and/or transmission component 1004 depicted in FIG. 10) may transmit the indication, as described above.

As further shown in FIG. 8, in some aspects, process 800 may include transmitting the downlink communication (block 830). For example, the network entity (e.g., using communication manager 1008 and/or transmission component 1004) depicted in FIG. 10 may transmit the downlink communication, as described above.

Process 800 may include additional aspects, such as any single aspect or any combination of aspects described below and/or in connection with one or more other processes described elsewhere herein.

In a first aspect, the frequency domain granularity indicates one or more subcarriers.

In a second aspect, alone or in combination with the first aspect, the frequency domain granularity corresponds to a PRG, or a size of a PRG.

In a third aspect, alone or in combination with one or more of the first and second aspects, the frequency domain granularity corresponds to an RB group (or a size of an RB group) associated with a PRG.

In a fourth aspect, alone or in combination with one or more of the first through third aspects, the time domain granularity indicates one or more symbols or slots.

In a fifth aspect, alone or in combination with one or more of the first through fourth aspects, transmitting the indication includes transmitting the indication via a downlink grant DCI, an RRC configuration, or a MAC CE.

In a sixth aspect, alone or in combination with one or more of the first through fifth aspects, generating the indication includes generating the indication based at least in part on CSI or a measurement of a reference signal.

In a seventh aspect, alone or in combination with one or more of the first through sixth aspects, the indication indicates one or more of a BLER, a size, an MCS, or channel profile information.

In an eighth aspect, alone or in combination with one or more of the first through seventh aspects, the performance-complexity tradeoff parameter value is specific to a frequency subband, a BWP, or a serving cell.

In a ninth aspect, alone or in combination with one or more of the first through eighth aspects, the performance-complexity tradeoff parameter value is associated with one or more of a constellation size or a quantity of layers.

In a tenth aspect, alone or in combination with one or more of the first through ninth aspects, generating the indication includes performing machine learning with one or more model inputs.

In an eleventh aspect, alone or in combination with one or more of the first through tenth aspects, the one or more model inputs include one or more of packet data protocol information, a coarse frequency selectivity level, an actual frequency selectivity level, a coarse channel singularity level, an actual channel singularity level, Doppler information, actual Doppler information, Doppler spread information, actual Doppler spread information, channeling coherence time information, a target BLER, a constellation size, an MCS, a quantity of layers, a quantity of receive antennas, or a history of channel measurements.

In a twelfth aspect, alone or in combination with one or more of the first through eleventh aspects, process 800 includes transmitting one or more machine learning models for a user equipment to obtain the performance-complexity tradeoff parameter value, the frequency domain granularity, or the time domain granularity.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE (e.g., a UE 120, UE 620), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, a network entity, or another wireless communication device) using the reception component 902 and the transmission component 904. As further shown, the apparatus 900 may include the communication manager 908. The communication manager 908 may control and/or otherwise manage one or more operations of the reception component 902 and/or the transmission component 904. In some aspects, the communication manager 908 may include one or more antennas, a modem, a controller/processor, a memory, or a combination thereof, of the UE described in connection with FIG. 2. The communication manager 908 may be, or be similar to, the communication manager 150 depicted in FIGS. 1 and 2. For example, in some aspects, the communication manager 908 may be configured to perform one or more of the functions described as being performed by the communication manager 150. In some aspects, the communication manager 908 may include the reception component 902 and/or the transmission component 904. The communication manager 908 may include a parameter component 910, a reduction component 912, and/or a detection component 914, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The parameter component 910 may obtain (by indication or machine learning) one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The reception component 902 may receive the downlink communication that corresponds to the first matrix. The reduction component 912 may perform the lattice reduction to transfer the first matrix to a second matrix based at least in part on the one or more of the performance-complexity tradeoff parameter value, the frequency domain granularity, or the time domain granularity. The detection component 914 may perform MIMO detection of the downlink communication using the second matrix.

The reduction component 912 may disable a lattice reduction of a next downlink communication based at least in part on a determination that the next downlink communication includes multiple DMRSs.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity (e.g., base station 110, network entity 610), or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, a network entity, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the network entity described in connection with FIG. 2. The communication manager 1008 may be, or be similar to, the communication manager 150 depicted in FIGS. 1 and 2. For example, in some aspects, the communication manager 1008 may be configured to perform one or more of the functions described as being performed by the communication manager 150. In some aspects, the communication manager 1008 may include the reception component 1002 and/or the transmission component 1004. The communication manager 1008 may include a parameter component 1010, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The parameter component 1010 may generate an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction. The transmission component 1004 may transmit the indication. The transmission component 1004 may transmit the downlink communication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: obtaining one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction; receiving the downlink communication that corresponds to the first matrix; performing the lattice reduction to transfer the first matrix to a second matrix based at least in part on the one or more of the performance-complexity tradeoff parameter value, the frequency domain granularity, or the time domain granularity; and performing multiple-input-multiple-output detection of the downlink communication using the second matrix.

Aspect 2: The method of Aspect 1, wherein the frequency domain granularity indicates one or more subbands, and wherein performing the lattice reduction based at least in part on the frequency domain granularity includes applying the lattice reduction identically across the one or more subbands.

Aspect 3: The method of Aspect 1 or 2, wherein the frequency domain granularity corresponds to a precoding resource block granularity.

Aspect 4: The method of Aspect 1 or 2, wherein the frequency domain granularity corresponds to a resource block group associated with a precoding resource block granularity.

Aspect 5: The method of any of Aspects 1-4, wherein the time domain granularity indicates one or more symbols or slots, and wherein performing the lattice reduction based at least in part on the time domain granularity includes applying the lattice reduction identically across the one or more symbols or slots.

Aspect 6: The method of any of Aspects 1-5, wherein performing the lattice reduction includes performing the lattice reduction based at least in part on a determination that the downlink communication includes a demodulation reference signal.

Aspect 7: The method of any of Aspects 1-6, wherein performing the lattice reduction includes performing the lattice reduction based at least in part on a determination that the downlink communication does not include multiple demodulation reference signals.

Aspect 8: The method of any of Aspects 1-7, further comprising disabling a lattice reduction of a next downlink communication based at least in part on a determination that the next downlink communication includes multiple demodulation reference signals.

Aspect 9: The method of any of Aspects 1-8, wherein obtaining the performance-complexity tradeoff parameter value, the frequency domain granularity, or the time domain granularity includes receiving an indication of the performance-complexity tradeoff parameter value, the frequency domain granularity, or the time domain granularity via a downlink grant downlink control information, a radio resource control configuration, or a medium access control control element (MAC CE).

Aspect 10: The method of any of Aspects 1-9, further comprising receiving an indication of one or more of a block error rate, a constellation size, a modulation and coding scheme, or channel profile information.

Aspect 11: The method of any of Aspects 1-10, wherein the performance-complexity tradeoff parameter value is specific to a frequency subband, a bandwidth part, or a serving cell.

Aspect 12: The method of any of Aspects 1-11, wherein the performance-complexity tradeoff parameter value is associated with one or more of a constellation size or a quantity of layers.

Aspect 13: The method of any of Aspects 1-12, wherein obtaining the indication includes performing machine learning with one or more model inputs.

Aspect 14: The method of Aspect 13, wherein the one or more model inputs include one or more of: packet data protocol information, a coarse frequency selectivity level, an actual frequency selectivity level, a coarse channel singularity level, an actual channel singularity level, coarse Doppler information, actual Doppler information, coarse Doppler spread information, actual Doppler spread information, channel coherence time information, a target block error rate, a constellation size, a modulation and coding scheme, a quantity of layers, a quantity of receive antennas, or a history of channel measurements.

Aspect 15: The method of Aspect 13, further comprising receiving one or more models for the machine learning.

Aspect 16: A method of wireless communication performed by a network entity, comprising: generating an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction; transmitting the indication; and transmitting the downlink communication.

Aspect 17: The method of Aspect 16, wherein the frequency domain granularity indicates one or more subcarriers.

Aspect 18: The method of Aspect 16 or 17, wherein the frequency domain granularity corresponds to a precoding resource block granularity.

Aspect 19: The method of Aspect 16 or 17, wherein the frequency domain granularity corresponds to a resource block group associated with a precoding resource block granularity.

Aspect 20: The method of any of Aspects 15-18, wherein the time domain granularity indicates one or more symbols or slots.

Aspect 21: The method of any of Aspects 16-20, wherein transmitting the indication includes transmitting the indication via a downlink grant downlink control information, a radio resource control configuration, or a medium access control control element (MAC CE).

Aspect 22: The method of any of Aspects 16-21, wherein generating the indication includes generating the indication based at least in part on channel state information or a measurement of a reference signal.

Aspect 23: The method of any of Aspects 16-22, wherein the indication indicates one or more of a block error rate, a size, a modulation and coding scheme, or channel profile information.

Aspect 24: The method of any of Aspects 16-23, wherein the performance-complexity tradeoff parameter value is specific to a frequency subband, a bandwidth part, or a serving cell.

Aspect 25: The method of any of Aspects 16-24, wherein the performance-complexity tradeoff parameter value is associated with one or more of a constellation size or a quantity of layers.

Aspect 26: The method of any of Aspects 16-25, wherein generating the indication includes performing machine learning with one or more model inputs.

Aspect 27: The method of Aspect 26, wherein the one or more model inputs include one or more of: packet data protocol information, a coarse frequency selectivity level, an actual frequency selectivity level, a coarse channel singularity level, an actual channel singularity level, coarse Doppler information, actual Doppler information, coarse Doppler spread information, actual Doppler spread information, channel coherence time information, a target block error rate, a constellation size, a modulation and coding scheme, a quantity of layers, a quantity of receive antennas, or a history of channel measurements.

Aspect 28: The method of Aspect 26, further comprising transmitting one or more machine learning models for a user equipment to obtain the performance-complexity tradeoff parameter value, the frequency domain granularity, or the time domain granularity.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c.a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
obtain one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction;
receive the downlink communication that corresponds to the first matrix;
perform the lattice reduction to transfer the first matrix to a second matrix based at least in part on the one or more of the performance-complexity tradeoff parameter value, the frequency domain granularity, or the time domain granularity; and
perform multiple-input-multiple-output detection of the downlink communication using the second matrix.

2. The UE of claim 1, wherein the frequency domain granularity indicates one or more subbands, and wherein the one or more processors, to perform the lattice reduction based at least in part on the frequency domain granularity, are configured to apply the lattice reduction identically across the one or more subbands.

3. The UE of claim 1, wherein the frequency domain granularity corresponds to a precoding resource block granularity.

4. The UE of claim 1, wherein the frequency domain granularity corresponds to a resource block group associated with a precoding resource block granularity.

5. The UE of claim 1, wherein the time domain granularity indicates one or more symbols or slots, and wherein the one or more processors, to perform the lattice reduction based at least in part on the time domain granularity, are configured to apply the lattice reduction identically across the one or more symbols or slots.

6. The UE of claim 1, wherein the one or more processors, to perform the lattice reduction, are configured to perform the lattice reduction based at least in part on a determination that the downlink communication includes a demodulation reference signal.

7. The UE of claim 1, wherein the one or more processors, to perform the lattice reduction, are configured to perform the lattice reduction based at least in part on a determination that the downlink communication does not include multiple demodulation reference signals.

8. The UE of claim 1, wherein the one or more processors are configured to disable a lattice reduction of a next downlink communication based at least in part on a determination that the next downlink communication includes multiple demodulation reference signals.

9. The UE of claim 1, wherein the one or more processors, to obtain the performance-complexity tradeoff parameter value, the frequency domain granularity, or the time domain granularity, are configured to receive an indication of the performance-complexity tradeoff parameter value, the frequency domain granularity, or the time domain granularity via a downlink grant downlink control information, a radio resource control configuration, or a medium access control control element (MAC CE).

10. The UE of claim 1, wherein the one or more processors are configured to receive an indication of one or more of a block error rate, a constellation size, a modulation and coding scheme, or channel profile information.

11. The UE of claim 1, wherein the performance-complexity tradeoff parameter value is specific to a frequency subband, a bandwidth part, or a serving cell.

12. The UE of claim 1, wherein the performance-complexity tradeoff parameter value is associated with one or more of a constellation size or a quantity of layers.

13. The UE of claim 1, wherein the one or more processors, to obtain the performance-complexity tradeoff parameter value, the frequency domain granularity, are configured to perform machine learning with one or more model inputs.

14. The UE of claim 13, wherein the one or more model inputs include one or more of:
packet data protocol information,
a coarse frequency selectivity level,
an actual frequency selectivity level,
a coarse channel singularity level,
an actual channel singularity level,
coarse Doppler information,
actual Doppler information,
coarse Doppler spread information,
actual Doppler spread information,
channel coherence time information,
a target block error rate,
a constellation size,
a modulation and coding scheme,
a quantity of layers,
a quantity of receive antennas, or
a history of channel measurements.

15. The UE of claim 13, wherein the one or more processors are configured to receive one or more models for the machine learning.

16. A network entity for wireless communication, comprising:
a memory; and
one or more processors, coupled to the memory, configured to:
generate an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction;
transmit the indication; and
transmit the downlink communication.

17. The network entity of claim 16, wherein the frequency domain granularity indicates one or more subcarriers.

18. The network entity of claim 16, wherein the frequency domain granularity corresponds to a precoding resource block granularity.

19. The network entity of claim 16, wherein the frequency domain granularity corresponds to a resource block group associated with a precoding resource block granularity.

20. The network entity of claim 16, wherein the time domain granularity indicates one or more symbols or slots.

21. The network entity of claim 16, wherein the one or more processors, to transmit the indication, are configured to transmit the indication via a downlink grant downlink control information, a radio resource control configuration, or a medium access control control element (MAC CE).

22. The network entity of claim 16, wherein the one or more processors, to generate the indication, are configured to generate the indication based at least in part on channel state information or a measurement of a reference signal.

23. The network entity of claim 16, wherein the indication indicates one or more of a block error rate, a size, a modulation and coding scheme, or channel profile information.

24. The network entity of claim 16, wherein the performance-complexity tradeoff parameter value is specific to a frequency subband, a bandwidth part, or a serving cell.

25. The network entity of claim 16, wherein the performance-complexity tradeoff parameter value is associated with one or more of a constellation size or a quantity of layers.

26. The network entity of claim 16, wherein the one or more processors, to generate the indication, are configured to perform machine learning with one or more model inputs.

27. The network entity of claim 26, wherein the one or more model inputs include one or more of:
packet data protocol information,
a coarse frequency selectivity level,
an actual frequency selectivity level,
a coarse channel singularity level,
an actual channel singularity level,
coarse Doppler information,
actual Doppler information,
coarse Doppler spread information,
actual Doppler spread information,
channel coherence time information,
a target block error rate,
a constellation size,
a modulation and coding scheme,
a quantity of layers,
a quantity of receive antennas, or
a history of channel measurements.

28. The network entity of claim 26, wherein the one or more processors are configured to transmit one or more machine learning models for a user equipment to obtain the performance-complexity tradeoff parameter value, the frequency domain granularity, or the time domain granularity.

29. A method of wireless communication performed by a user equipment (UE), comprising:
obtaining one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction;
receiving the downlink communication that corresponds to the first matrix;
performing the lattice reduction to transfer the first matrix to a second matrix based at least in part on the one or more of the performance-complexity tradeoff parameter value, the frequency domain granularity, or the time domain granularity; and
performing multiple-input-multiple-output detection of the downlink communication using the second matrix.

30. A method of wireless communication performed by a network entity, comprising:
generating an indication of one or more of a performance-complexity tradeoff parameter value associated with a quantity of iterations and channel orthogonality for an algorithm for a lattice reduction of a first matrix for a downlink communication, a frequency domain granularity for the lattice reduction, or a time domain granularity for the lattice reduction;
transmitting the indication; and
transmitting the downlink communication.
